(19) United States
(12) Patent Application Publication
(10) Pub. No.: US 2017/0134242 A1
(43) Pub. Date: May 11, 2017

(54) SYSTEMS FOR SOFTWARE AND HARDWARE MANAGEMENT

(71) Applicant: Rodney Ridl, Tigard, OR (US)

(72) Inventor: Rodney Ridl, Tigard, OR (US)

(21) Appl. No.: 15/331,699

(22) Filed: Oct. 21, 2016

Related U.S. Application Data
(60) Provisional application No. 62/244,579, filed on Oct. 21, 2015.

(51) Int. Cl. H04L 12/24; H04L 29/08; G06N 99/00

(52) U.S. Cl. CPC H04L 41/16; G06N 99/005; H04L 67/34; H04L 67/42

(57) ABSTRACT

Systems and methods for automatic management of software and hardware including an autonomic layer that employs an artificial intelligence engine and rules to manage the software and hardware environment. Client embedded programs (CEPs) are deployed upon all managed software and hardware, and communicate with corresponding CEPs in the autonomic layer. In some examples, an additional switch CEP is deployed to mediate between the CEPs to enhance security by isolating managed systems.

### CROSS REFERENCE TO RELATED APPLICATIONS

This application claims priority to copending U.S. Application, Ser. No. 62/244,579, filed on 21 Oct. 2015, which is hereby incorporated by reference in its entirety for all purposes, including all attachments and exhibits thereto.

### BACKGROUND

The present disclosure relates generally to systems for automating management of software and hardware infrastructure. In particular, systems that apply machine learning and artificial intelligence to facilitate complete management of information technology (IT) infrastructure in organizations are described.

Modern businesses of all sizes run on increasingly sophisticated IT infrastructures that are often comprised of a variety of different equipment and software from an array of vendors. Adding to complexities are custom software developments to address specific and unique business needs and, in the case of some specialized businesses, specialized and custom hardware. As IT infrastructure grows in size and/or is increasingly dependent upon specialized software and hardware, the management requirements and associated costs also grow. While smaller organizations may be able to effectively manage and maintain their IT infrastructure with a part time IT services provider, larger organizations may have dedicated personnel, or even entire departments devoted solely to a continuous process of IT infrastructure maintenance, repair, management, and deployment. Larger organizations also need to have strategic plans for IT infrastructure development and deployment, with particular attention made to long term investments and strategies that ideally are coordinated with the organization's strategic business plans, so that any necessary infrastructure is in place in a timely fashion for the organization to see strategic plans and vision executed without delay.

Known methods of IT management are not entirely satisfactory for the range of applications in which they are employed. For example, employing the aforementioned IT personnel represents an ongoing investment in personnel and the commensurate associated costs (payroll, benefits, pension, etc.). Reliable and experienced IT staff can be difficult to locate and retain, and unreliable IT staff may exacerbate the problems they were intended to solve, resulting in lost business opportunities. Furthermore, even the best IT staff may miss critical problems from time to time, or may fail to correctly prioritize management tasks in a fashion that coordinates with business strategy.

Automated systems and methods of IT management are currently known in the prior art; however, such systems and methods tend to be focused on either automating wide-scale management tasks that are preselected by existing IT management staff, or enabling centralized management of a geographically dispersed system. The systems themselves fail to provide higher level IT management, such as anticipating IT needs and making the sorts of maintenance decisions and carrying out repair strategies and tasks that would normally be done by IT staff.

Thus, there exists a need for more automated systems for software and hardware management that improve upon and advance the design of known systems and methods. Examples of new and useful systems for software and hardware management relevant to the needs existing in the field are discussed below.

### SUMMARY

The present disclosure is directed to a system for automated management of a computing environment including one or more client components, comprising a storage unit configured to store processor executable instructions, wherein the processor executable instructions further comprise an autonomic layer comprised of a management image including management protocols, and one or more sister client embedded programs; and one or more brother client embedded programs; wherein each of the one or more brother client embedded programs is executed upon one of the one or more client components; each of the one or more brother client embedded programs has, and is in data communication with, a corresponding one of the one or more sister client embedded programs; and the autonomic layer employs artificial intelligence algorithms to automatically probe each of the one or more client components of the computing environment and adapt the management protocols to changes in the computing environment, by communicating with the brother client embedded program executing on each of the one or more client components via each brother client embedded program's corresponding sister client embedded program.

According to one aspect, the management image is further comprised of the management image and one or more working images.

According to another aspect, the autonomic layer is further comprised of an artificial intelligence engine, system interrogation layer, system database layer, systems rules and algorithms layer, real-time storage and systems analyzer layer, and governance and compliance layer.

According to yet another aspect, the artificial intelligence engine is further comprised of independent modules that are in data communication with each other.

According to still another aspect, the management protocols are based upon a set of algorithm-based rules that are unique to the computing environment.

According to another aspect, the system is further comprised of one or more switch client embedded programs, wherein each brother client embedded program is in data communication with its corresponding sister client embedded program through a switch client embedded program.

According to another aspect, the processor executable instructions for the autonomic layer are executed upon a management server.

According to still another aspect, the management server comprises one or more standalone rack mount servers.

In another embodiment of the disclosed invention, a method of automatically managing a computing environment comprised of a plurality of client components further comprises establishing an autonomic layer on a management server, the autonomic layer further comprising an artificial intelligence engine; establishing algorithm-based rules specific to the computing environment; configuring the artificial intelligence engine with the algorithm-based rules to manage the computing environment; establishing a brother client embedded program on each of the plurality of client components; establishing a plurality of sister client embedded programs within the autonomic layer, each of the plurality of sister client embedded programs corresponding to and in two-way data communication with one of the brother client embedded programs; and using the artificial intelligence engine to manage each of the plurality of client components through each of the brother client embedded programs and corresponding sister client embedded programs.

According to one aspect of the embodiment, the method further comprises establishing one or more switch client embedded programs; and configuring each of the brother client embedded programs and corresponding sister client embedded programs to be in two-way data communication through one of the one or more switch client embedded programs.

According to another aspect of the embodiment, the artificial intelligence engine further comprises a plurality of management modules.

According to yet another aspect of the embodiment, the method further comprises intercepting by one of the brother client embedded programs all user input into a client component, and passing the input to the brother client embedded program's corresponding sister embedded program for further processing in accordance with algorithm-based rules.

According to another aspect of the embodiment, the method further comprises configuring each brother client embedded program and corresponding sister client embedded program to monitor the status of its respective client component; and configuring the autonomic layer to dynamically reconfigure the plurality of client components in response to changing user needs, in accordance with the algorithm-based rules.

According to another aspect of the embodiment, the method further comprises configuring the autonomic layer to dynamically adjust management of the computing environment based upon the algorithm-based rules in response to changes in the computing environment.

According to another aspect of the embodiment, the method further comprises configuring the autonomic layer to probe the computing environment to discover and determine the nature and status of each of the plurality of client components; and deploying a brother client embedded program upon any of the plurality of client components that the autonomic layer determines does not have a brother client embedded program and a corresponding sister client embedded program within the autonomic layer.

According to still another aspect of the embodiment, the method further comprises configuring the autonomic layer to isolate all client components from any direct interactions apart from the autonomic layer.

In yet another embodiment, a management server is comprised of a processor configured to execute instructions; a network interface in data communication with the processor and configured to communicate with client components over a network; and a storage device in data communication with the processor and configured to store processor executable instructions, wherein the instructions comprise an autonomic layer further comprised of an artificial intelligence engine, system interrogation layer, system database layer, systems rules and algorithms layer, real-time storage and systems analyzer layer, and governance and compliance layer, a brother client embedded program configured to be instantiated upon each of the network connected client components, and a sister client embedded program configured to be instantiated within the autonomic layer for each brother client embedded program; wherein the autonomic layer is configured to discover all network connected client components, instantiate a brother client embedded program upon each network connected client component, and manage each network connected client component via its instantiated brother client embedded program.

According to one aspect of the embodiment, each brother client embedded program is configured to communicate with a corresponding sister client program via a switch client embedded program.

According to another aspect of the embodiment, the server is further comprised of one or more rack mountable appliances.

According to yet another aspect of the embodiment, each client component is a server, desktop, laptop, tablet, smartphone, network device, or mobile device.

### BRIEF DESCRIPTION OF THE DRAWINGS

FIG. 1 shows a schematic view of an example of a programmable computing device.

FIG. 2 shows a schematic view of an example of a mobile electronic device.

FIG. 3 is a block diagram of an example of a system for software and hardware management.

FIG. 4 is a block diagram of the system for software and hardware management shown in FIG. 3 depicting the components of the autonomic layer.

FIG. 5 is a block diagram of the system for software and hardware management shown in FIG. 3 depicting the interaction between the artificial intelligence engine and client components.

FIG. 6 is a block diagram of the system for software and hardware management shown in FIG. 3 depicting artificial intelligence engine and its interaction with the system interrogation and system database layers.

FIG. 7 is a block diagram of the system for software and hardware management shown in FIG. 3 depicting the artificial intelligence engine's interaction with the system rules and algorithms layer.

FIG. 8 is a block diagram of the system for software and hardware management shown in FIG. 3 depicting the real-time storage and systems analyzer layer, and its interaction within the autonomic layer.

FIG. 9 is a block diagram of the system for software and hardware management shown in FIG. 3 depicting the interaction between the artificial intelligence engine and the governance and compliance layer.

FIG. 10 is a block diagram of the system for software and hardware management shown in FIG. 3 depicting the components of a brother client embedded program.

FIG. 11 is a block diagram of the system for software and hardware management shown in FIG. 3 depicting the additional switch client embedded program.

FIG. 12 is a flowchart of the system for software and hardware management shown in FIG. 3 depicting the steps the system uses to initialize and begin management of software and hardware.

FIG. 13 is a block diagram of an example management appliance and associated worker appliance on which the system for software and hardware management shown in FIG. 3 may be deployed.

### DETAILED DESCRIPTION

The disclosed systems and methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various systems and methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

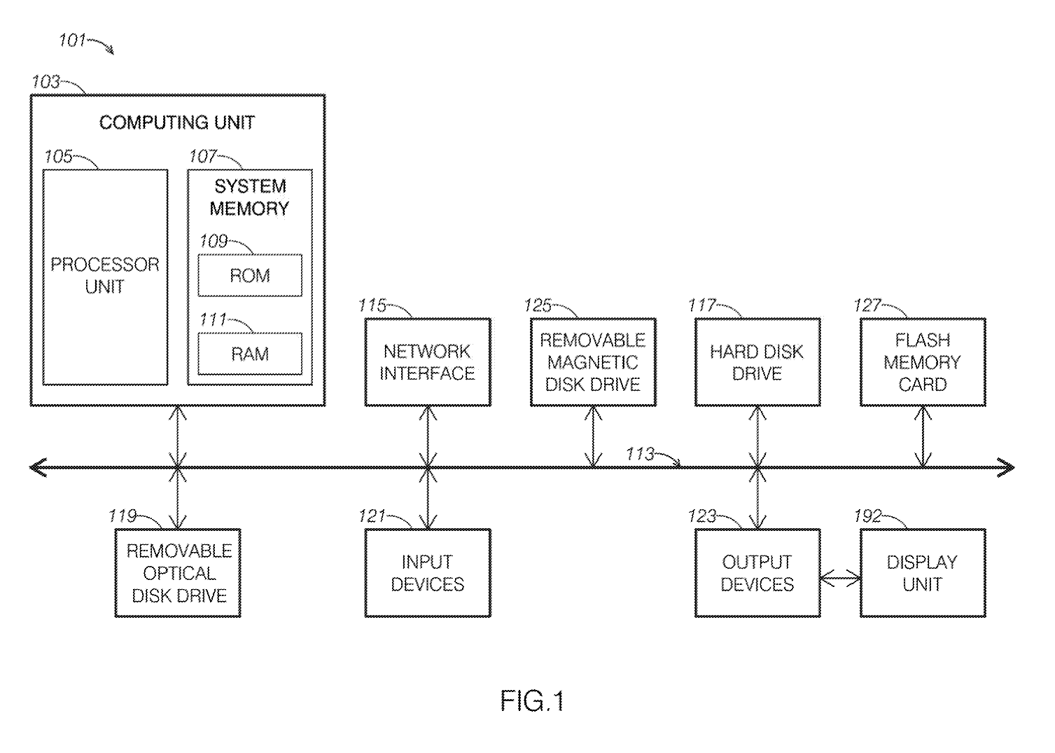

Accordingly, FIG. 1 shows one illustrative example of a computer, computer 101, which can be used to implement various embodiments of the invention. Computer 101 may be incorporated within a variety of consumer electronic devices, such as personal media players, cellular phones, smart phones, personal data assistants, global positioning system devices, and the like.

As seen in this figure, computer 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include, for example, a monitor display, an integrated display, television, printer, stereo, or speakers.

Still further, computing unit 103 will be directly or indirectly connected to one or more network interfaces 115 for communicating with a network. This type of network interface 115 is also sometimes referred to as a network adapter or network interface card (NIC). Network interface 115 translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 101 may be connected to a digital music player, such as an IPOD® brand digital music player or iOS or Android based smartphone. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone,” such as those featuring the Android or iOS operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that their data maintained may be synchronized.

Of course, still other peripheral devices may be included with or otherwise connected to a computer 101 of the type illustrated in FIG. 1, as is well known in the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data “port,” such as Bluetooth® interface, a Wi-Fi interface, an infrared data port, or the like.

It should be appreciated that a computing device employed according to the various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

In many examples, computers may define mobile electronic devices, such as smartphones, tablet computers, or portable music players, often operating the iOS, Symbian, Windows-based (including Windows Mobile and Windows 8), or Android operating systems.

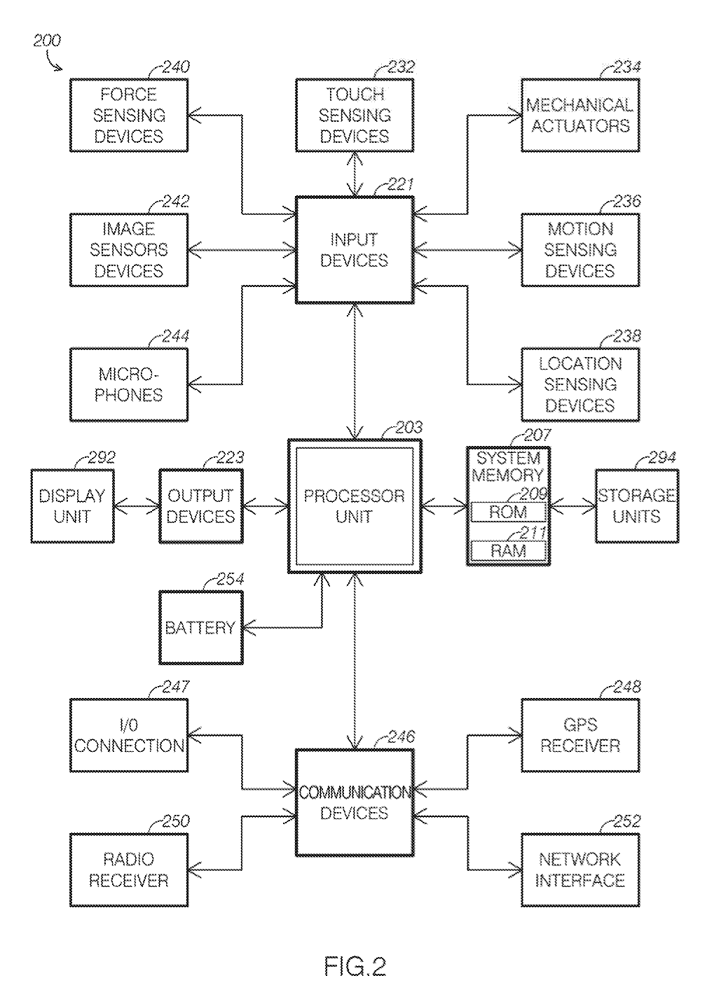

With reference to FIG. 2, an exemplary mobile device, mobile device 200, may include a processor unit 203 (e.g., CPU) configured to execute instructions and to carry out operations associated with the mobile device. For example, using instructions retrieved from memory, the controller may control the reception and manipulation of input and output data between components of the mobile device. The controller can be implemented on a single chip, multiple chips or multiple electrical components. For example, various architectures can be used for the controller, including dedicated or embedded processor, single purpose processor, controller, ASIC, etc. By way of example, the controller may include microprocessors, DSP, A/D converters, D/A converters, compression, decompression, etc.

In most cases, the controller together with an operating system operates to execute computer code and produce and use data. The operating system may correspond to well-known operating systems such as iOS, Symbian, Windows-based (including Windows Mobile and Windows 8), or Android operating systems, or alternatively to special purpose operating system, such as those used for limited purpose appliance-type devices. The operating system, other computer code and data may reside within a system memory 207 that is operatively coupled to the controller. System memory 207 generally provides a place to store computer code and data that are used by the mobile device. By way of example, system memory 207 may include read-only memory (ROM) 209, random-access memory (RAM) 211, etc. Further, system memory 207 may retrieve data from storage units 294, which may include a hard disk drive, flash memory, etc. In conjunction with system memory 207, storage units 294 may include a removable storage device such as an optical disc player that receives and plays DVDs, or card slots for receiving mediums such as memory cards (or memory sticks).

Mobile device 200 also includes input devices 221 that are operatively coupled to processor unit 203. Input devices 221 are configured to transfer data from the outside world into mobile device 200. As shown, input devices 221 may correspond to both data entry mechanisms and data capture mechanisms. In particular, input devices 221 may include the following: touch sensing devices 232 such as touch screens, touch pads and touch sensing surfaces; mechanical actuators 234 such as button or wheels or hold switches; motion sensing devices 236 such as accelerometers; location detecting devices 238 such as global positioning satellite receivers, WiFi based location detection functionality, or cellular radio based location detection functionality; force sensing devices 240 such as force sensitive displays and housings; image sensors 242; and microphones 244. Input devices 221 may also include a clickable display actuator.

Mobile device 200 also includes various output devices 223 that are operatively coupled to processor unit 203. Output devices 223 are configured to transfer data from mobile device 200 to the outside world. Output devices 223 may include a display unit 292 such as an LCD, speakers or jacks, audio/tactile feedback devices, light indicators, and the like.

Mobile device 200 also includes various communication devices 246 that are operatively coupled to the controller. Communication devices 246 may, for example, include both an I/O connection 247 that may be wired or wirelessly connected to selected devices such as through IR, USB, or Firewire protocols, a global positioning satellite receiver 248, and a radio receiver 250 which may be configured to communicate over wireless phone and data connections. Communication devices 246 may also include a network interface 252 configured to communicate with a computer network through various means which may include wireless connectivity to a local wireless network, a wireless data connection to a cellular data network, a wired connection to a local or wide area computer network, or other suitable means for transmitting data over a computer network.

Mobile device 200 also includes a battery 254 and possibly a charging system. Battery 254 may be charged through a transformer and power cord or through a host device or through a docking station. In the cases of the docking station, the charging may be transmitted through electrical ports or possibly through an inductance charging means that does not require a physical electrical connection to be made.

The various aspects, features, embodiments or implementations of the invention described above can be used alone or in various combinations. The methods of this invention can be implemented by software, hardware or a combination of hardware and software. The invention can also be embodied as computer readable code on a computer readable medium. The computer readable medium is any data storage device that can store data which can thereafter be read by a computer system, including both transfer and non-transfer devices as defined above. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

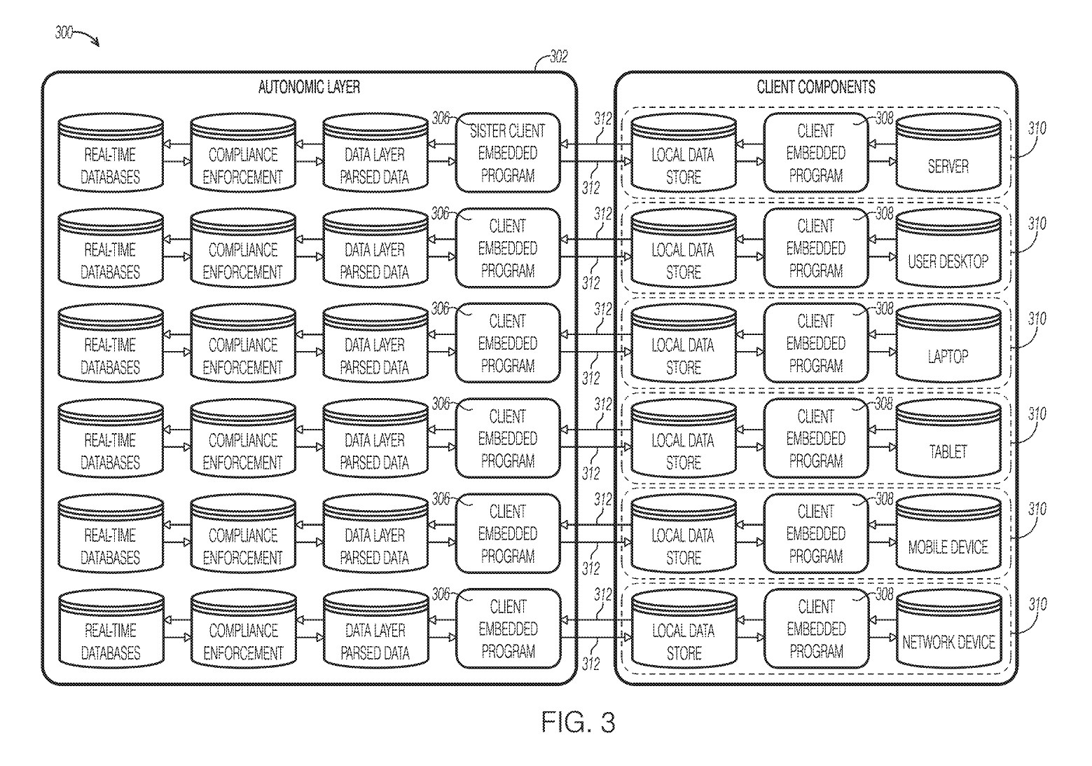

With reference to FIG. 3 a first example of a system for software and hardware management, system 300, will now be described. System 300 functions to provide complete management functionality over an organization's IT infrastructure, including both hardware and software components. By using artificial intelligence techniques and technology, system 300 intelligently automates and manages the complete technology stack of an enterprise's IT infrastructure. In its preferable configuration, system 300 is implemented as one or more dedicated network appliances that interact in a cross-platform fashion with existing IT equipment, such as file servers, desktop computers, laptop computers, network infrastructure, and mobile devices. Additionally, system 300 can also incorporate organization-level strategic and administrative planning, to help ensure that IT infrastructure is kept in an optimal state to meet future organizational goals. This includes, where appropriate, factoring in budgetary considerations. By deploying system 300, computer platforms and related architecture can be managed completely free of human interaction. Human interaction is thus limited to supplying information, criteria, data, patches, fixes, upgrades, updates and any/all other input via a rules and compliance interface. System authentication, verification, quality assurance and all other change management and version management applications are built in functions of system 300. Preferably, nothing is considered independent of system 300.

System 300 addresses many of the shortcomings existing with conventional IT infrastructure management systems and methods. For example, by automating much, if not all, of the mechanics of IT management, tasks that normally would be carried out by IT personnel can now be handled automatically. Thus, by deploying system 300 an enterprise can significantly reduce the problems of finding and retaining quality IT staff. Moreover, costs can be reduced by not having to provide benefits packages, and overall system uptime and reliability can be improved as system 300 provides for essentially continuous system maintenance. Similarly, system 300's modular design can be easily scaled to whatever size is appropriate to an enterprise's IT infrastructure needs. System 300, as suggested above, can take a more strategic role in automating planning of IT information, and then carrying out the necessary steps to deploy and maintain the planned IT infrastructure.

System 300 is fundamentally software applied to any technology system or device for the purpose of operating, securing or optimizing the functionality of the system or device. System 300 provides a framework of modules that create an operating environment in which technology systems and individual devices operate. Preferably, system 300 operates in a fashion similar to that of a hypervisor utilized in system virtualization solutions, namely by abstracting the various components of a system upon which it is deployed. System 300 operates on a level between the user or any other external device, and each component of the deployed system, thus moderating between users and the various software and hardware components. In such a position, system 300 takes precedent over any vendor or user added product, whether hardware or software. Without process or process management, system 300 can facilitate a secure, efficient and highly integrated environment in which OSs and all added hardware and software operate. System 300 can be deployed in a local fashion on a specific organization level system, could be cloud-based, or a hybrid implementation with some components being cloud-based and others locally deployed. Any configuration may be established as a private, public or hybrid implementation requiring stand-alone functionality and/or client/server-deployed objects, or a hybrid architecture of the foregoing. System 300 can be configured to monitor all types of electronic devices, including servers, desktops, laptops, as well as mobile devices such as smartphones and tables, and can manage all for security and performance. These devices are as a group referred to herein as client components 310. System 300 is scalable from a single device up to enterprise and data-center scale deployments.

As shown in FIG. 3, system 300 includes a storage unit configured to store processor executable instructions, wherein the processor executable instructions further comprise an autonomic layer 302 for managing one or more client components 310, one or more sister client embedded programs 306 that run within autonomic layer 302, and one or more brother client embedded programs 308. Each of the one or more brother client embedded programs 308 is executed upon a client component 310. Each of the brother client embedded programs 308 has, and is in data communication 312 with, a corresponding sister client embedded program 306.

Autonomic layer 302 employs artificial intelligence algorithms as part of artificial intelligence engine 402 to automatically probe each client component 310 of the computing environment, and adapt management protocols to changes in the computing environment, by communicating with the brother client embedded program 308 executing on each of the one or more client components 310 via each brother client embedded program's 308 corresponding sister client embedded program 306. Management protocols may include criteria for allocating computing environment resources, anticipating user needs, security measures, dynamic responses to detected intrusions attempts or threats to system integrity, role-based permissions and access control to environment resources, automatic deployment and repair of client components 310, and any other tasks that may ordinarily be carried out by an IT department or system admin. As with an IT department or system admin, the carrying out of these tasks may evolve depending upon dynamic variables in the computing environment; autonomic layer 302's use of AI engine 402 in conjunction with rules 418 enables system 300 to act in much the same fashion.

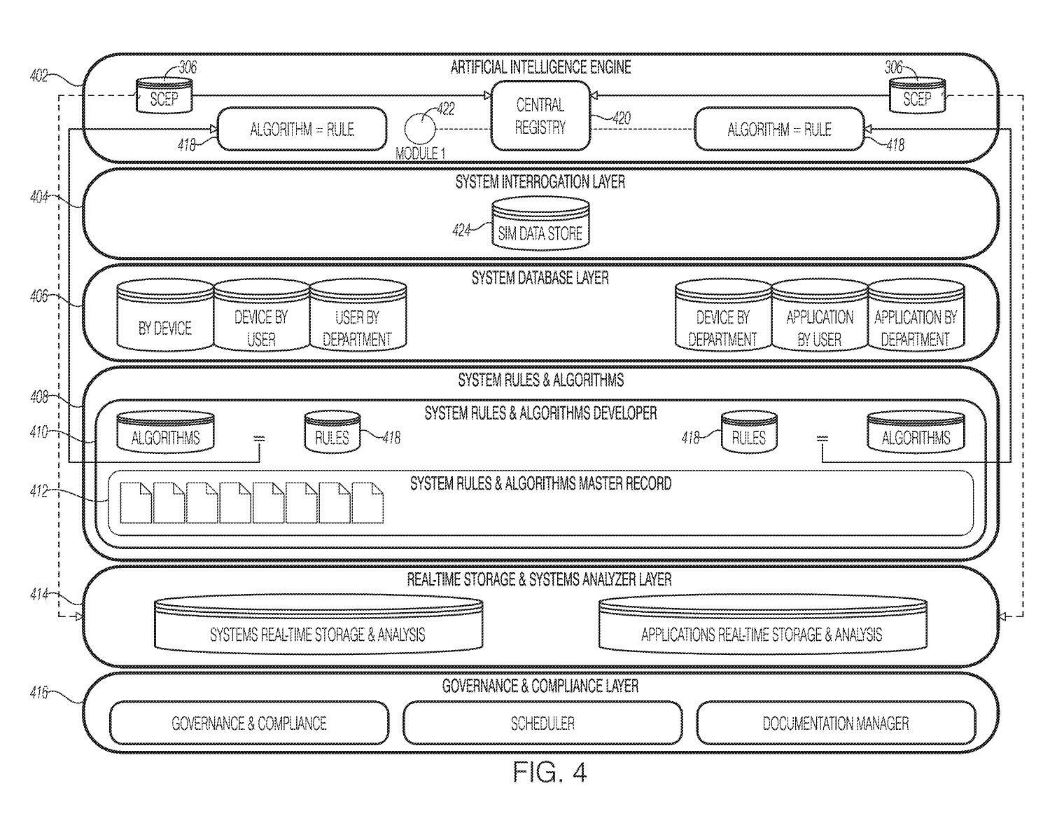

Referring to FIG. 4, the various components of autonomic layer 302 are depicted. Autonomic layer 302 is comprised of an artificial intelligence engine 402, a system interrogation layer 404, a system database layer 406, a systems rules and algorithms layer 408 that is further comprised of a systems rules and algorithms developer sublayer 410 and a systems rules and algorithms master record sublayer 412, a real-time storage and systems analyzer layer 414, and a governance and compliance layer 416. These various layers are conceptual only; in practice, the layers interact under the direction and in support of artificial intelligence engine 402, as will be explained below.

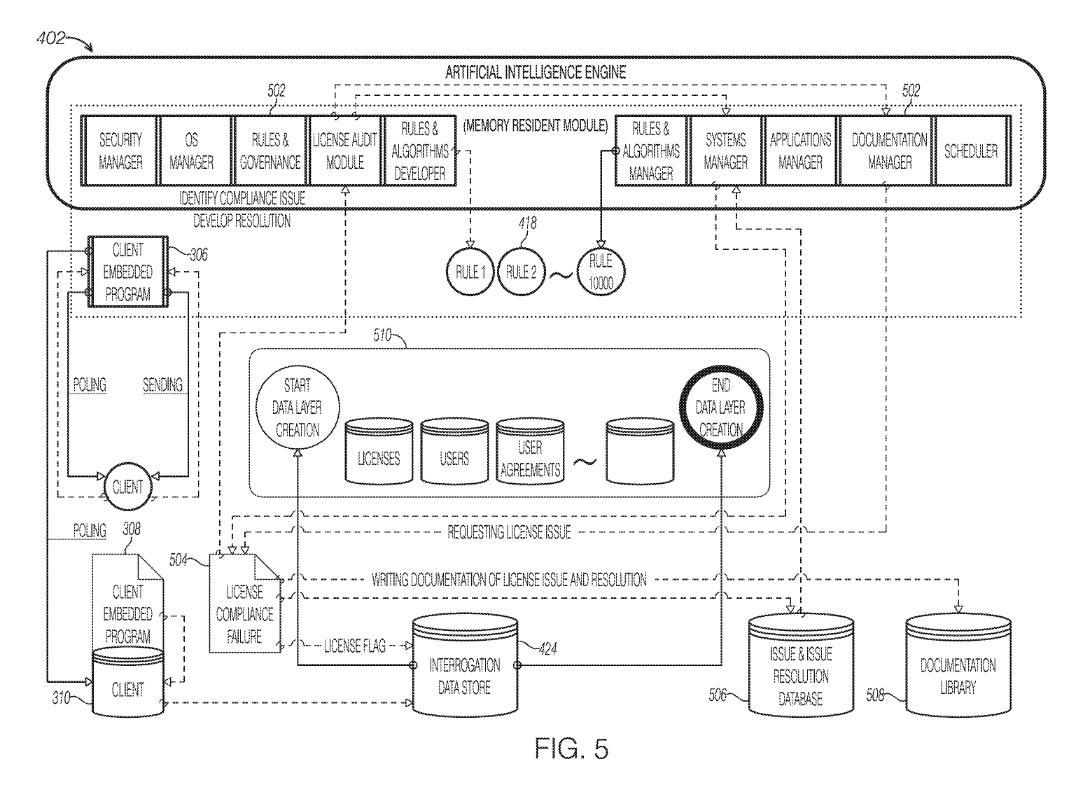

Artificial intelligence (AI) engine 402 is preferably implemented as an assembly of memory resident modules (see in FIG. 5) that can act independently and interactively as a message broker between one another with information regarding activity and actions to be taken. The specific artificial intelligence algorithms used to implement AI engine 402 can be any algorithms that are now known or later developed in the relevant art. AI engine 402 relies upon algorithm-based rules 418 to provide fundamental management behavior over the system upon which system 300 is deployed.

Algorithm-based rules 418 are typically supplied by the person or persons deploying system 300, and are tailored to the unique needs of the enterprise system upon which system 300 is deployed. Thus, algorithm-based rules 418 form the foundation upon which AI engine 402, and the larger autonomic layer 302, dynamically manage the system and various client components 310, in the development of management protocols. In addition to modules and algorithm-based rules 418, AI engine 402 includes a central registry 420 which can serve as the primary repository for information about the various client components 310 that are within the scope of system 300's management role. The use of AI engine 402, rules 418, and various databases with continual feeds from brother and sister client embedded programs 308 and 306, respectively, enables system 300 to dynamically and continually adjust to changing demands upon the computing environment. Management protocols will evolve in compliance with algorithm-based rules 418. Moreover, management protocols may, as needed, interact and modify algorithm-based rules 418, if the deployer of system 300 so determines.

Also seen in FIG. 4 are sister client embedded programs 306, which reside within the autonomic layer 302. As will be explained more below, sister client embedded programs 306 are instantiated on a one to one basis with brother client embedded programs 308, and are the primary means by which autonomic layer 302 engages with and manages the various client components 310. Data from sister client embedded programs 306, along with other parameters and relevant data collected by AI engine 402, may be placed into the various databases depicted in FIG. 4 being associated with system database layer 406.

Turning to FIG. 5, details of AI engine 402 as well as the interactions between AI engine 402 and client components 310 are depicted. AI engine 402 is shown with a variety of memory resident modules 502, all of which execute within the space of AI engine 402, and may have some interaction and be controlled by algorithm-based rules 418. The various modules 502 carry out the various functions of AI engine 402 as determined by algorithm-based rules 418. Such functions can include OS management, license auditing, security management, applications management, and documentation management.

Of greater import is the interaction between sister client embedded program 306 and brother client embedded program 308. Sister client embedded program 306 is clearly depicted residing within AI engine 402, along with modules 502. Conversely, brother client embedded program 308, which runs upon and manages client component 310, is external to AI engine 402, as it is external to autonomic layer 302.

Also depicted in FIG. 5 are various data stores, which are utilized by the various modules 502. For example, one of modules 502 is a license audit module, which in determining the existence of a license compliance failure 504 would coordinate data related to such a determination and place it into system interrogation data store 424. System interrogation data store 424 further may be in communication with various data stores 510 that may be logically located within system database layer 406. In similar fashion, issue & resolution database 506 and documentation library 508 may be utilized by system manager and documentation manager modules 502, as well as in determining license compliance failure 504.

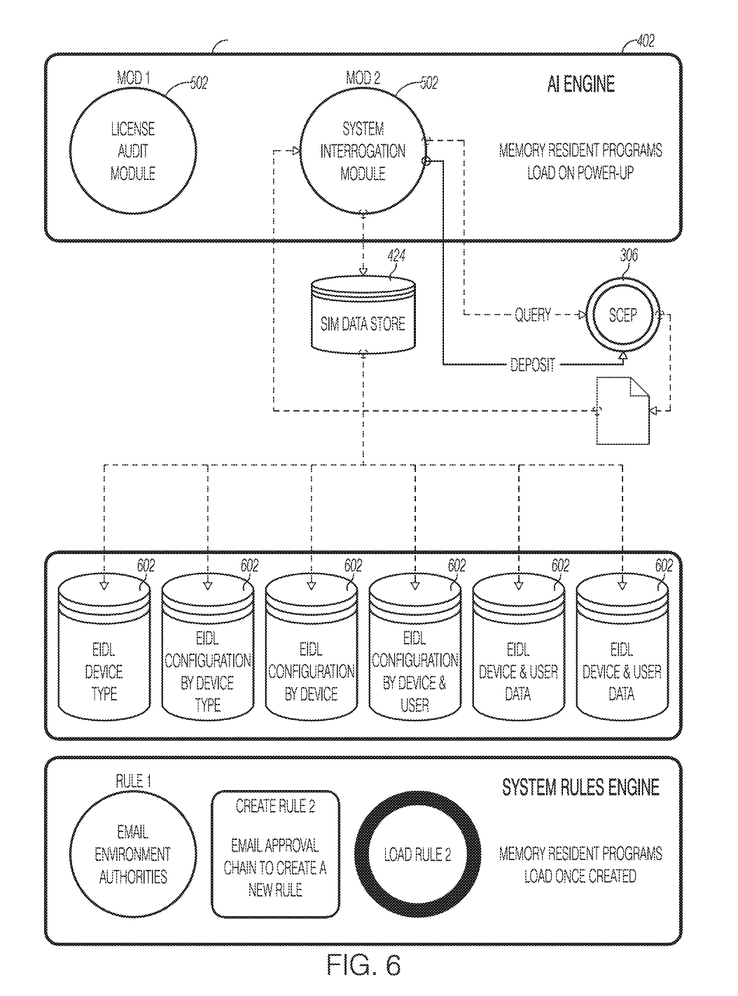

Referring to FIG. 6, modules 502 for a license audit module and the system interrogation module (SIM) which executes within AI engine 402 is shown. The SIM module, while logically within AI engine 402, also defines system interrogation layer 404 and it primary component, system interrogation data store 424. The SIM is a foundational module in that it supplies the system population processes with initialization data. The SIM checks for the presence of a brother client embedded program 308 on each client component 310. If none are found, a brother client embedded program 308 is deployed to an instantiated upon the client component 310 in question. AI engine 402 and the SIM repeat this process for all client components 310, and do so in an iterative fashion to ensure that all client components 310 within the purview of system 300 include a brother client embedded program 308 to allow management, until a given client component 310 is removed from system 300. Likewise, for every instance of a brother client embedded program 308, the SIM instantiates a corresponding sister client embedded program 306 within autonomic layer 302. This is preferably handled by the SIM, but could be handled by a different module, or other component of autonomic layer 302.

Brother client embedded programs (BCEP) 308 interrogate and monitor end-points, namely, client components 310, for changes and performance measurements. Any change in a monitored client component 310 triggers a flag to the SIM to receive a data dump. The SIM acknowledges the flag and schedules the dump. Client component's 310 brother CEP 308 sends the dump to the SIM at the scheduled time. Once the data is received by the SIM from BCEP 308 the SIM writes the data to the SIM data store 424. These steps may be processed iteratively for multiple BCEPs 308 and associated client components 310. Once the SIM acknowledges receipt of data from all BCEPs 308 the SIM creates or updated an enterprise information data layer (EIDL) 602 to manage and categorize received data dumps. EIDL 602 can logically be considered part of system database layer 406. The SIM continually monitors the various BCEPS 308 via sister CEPs 306 for flags indicating changes, requests for changes, etc. sent by BCEPs 308 going forward.

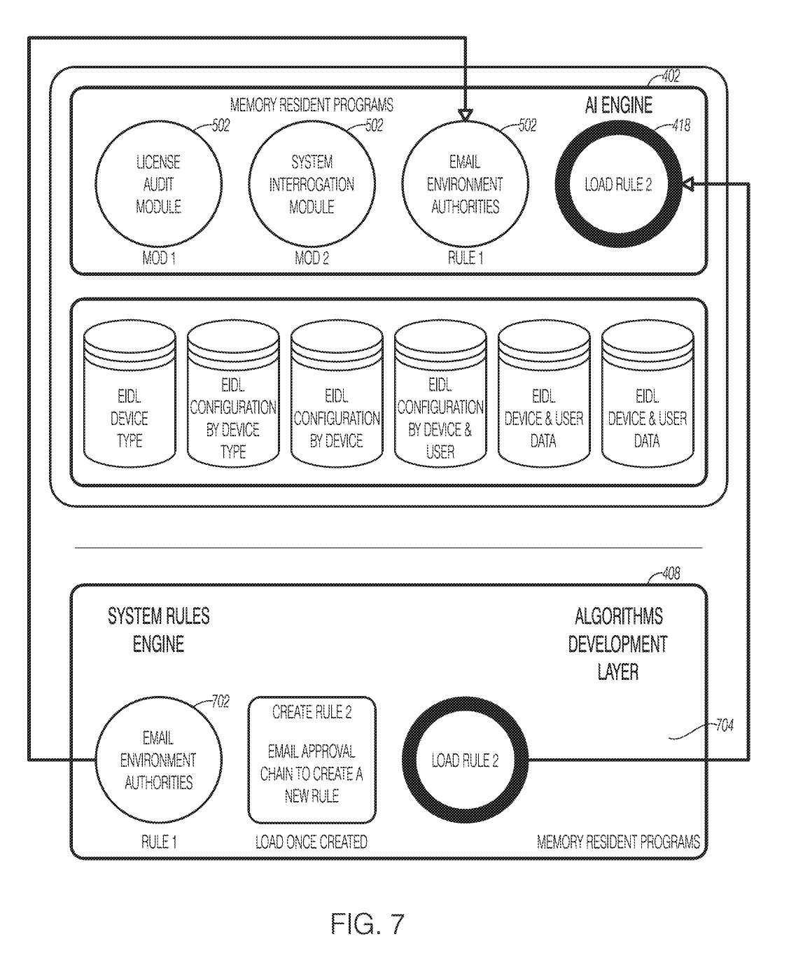

FIG. 7 depicts the interrelationship between AI engine 402 and system rules and algorithms layer 408, as well as interrelated sub layers 410 and 412. Part of system rules and algorithms later 408 is a system rules engine (SRE) 702. SRE 702 is a rules engine assigned to carry out logic and flow of messages compliant with ITIL and Zachman type frameworks, the two industry standard management frameworks that form a default rule set 418 to feed to AI engine 402. SRE 702 can preferably be implemented as a module 502 for execution within AI engine 402. Rules 418 are initially established by implementing these established, documented and accepted industry policies as a boiler-plate template; however, as mentioned above rules 418 are editable once system 300 is established. Also present is algorithms development layer (ADL) 704. ADL 704 is the error manager for SRE 702, and creates rules when none exist for a situation, e.g. a request is received to destruct an environment, no rule is found. ADL 704 will send approval request for the creation of a rule 418 to the proper chain of authorities defined by the enterprise deploying system 300 in the proper order. Once approvals are received, new rule 418 is created. Once a rule 418 is created the rule is loaded as a memory resident program 502 in to AI Engine 402, with all other memory resident modules 502.

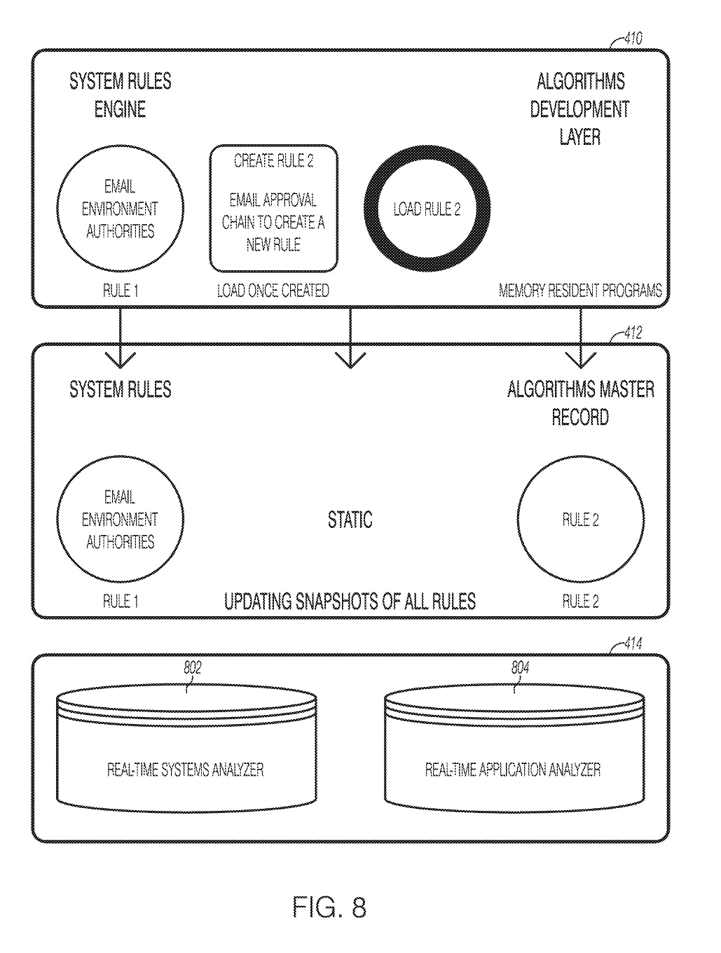

Turning to FIG. 8, real-time storage and systems analyzer layer 414 and its interaction with systems rules and algorithms developer sublayer 410 and system rules and algorithms master record sublayer 412 is depicted. System rules and algorithms master record sublayer 412 is the lower layer of the systems rules and algorithms layer 408. System rules and algorithms master record sublayer 412 is a database that holds static images of every system rule ever created from the initialization of the system. This layer 412 is editable and read only to interfaces other than those of systems rules and algorithms layer 408 and systems rules and algorithms developer sublayer 410. Analyzer Layer 414 is initialized by all of the data collected by the system interrogation layer 404 and becomes dependent on data supplied by the various BCEPs 308. Systems analyzer and applications analyzer databases 802 and 804 are real-time, run-time data acquisition repositories that have direct connections to every BCEP 308 for up to the instant data on every end-point. The analytics of these databases produce systems and performance profiles for up to the minute, real-time tuning and provisioning.

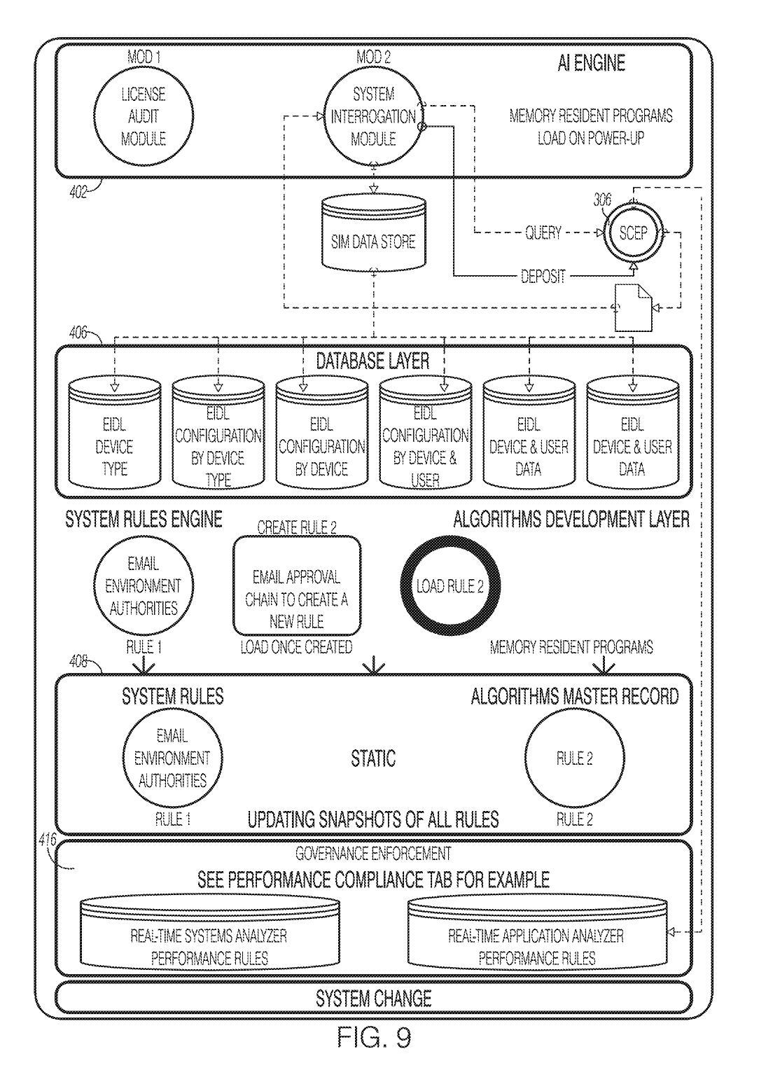

In FIG. 9, governance and compliance layer 416 is depicted as it interacts with AI engine 402, system database layer 406, and system rules and algorithms layer 408. Governance and compliance layer 416 also may contain a documentation manager and scheduler (shown in FIG. 4) for purposes of completeness. Governance and compliance layer 416 is literally the execution layer of every change to any system, process or program (algorithm). As such, governance and compliance layer 416 interfaces with instances of sister CEP 306 that correspond to targeted client components 310 to effect changes instructed by AI engine 402.

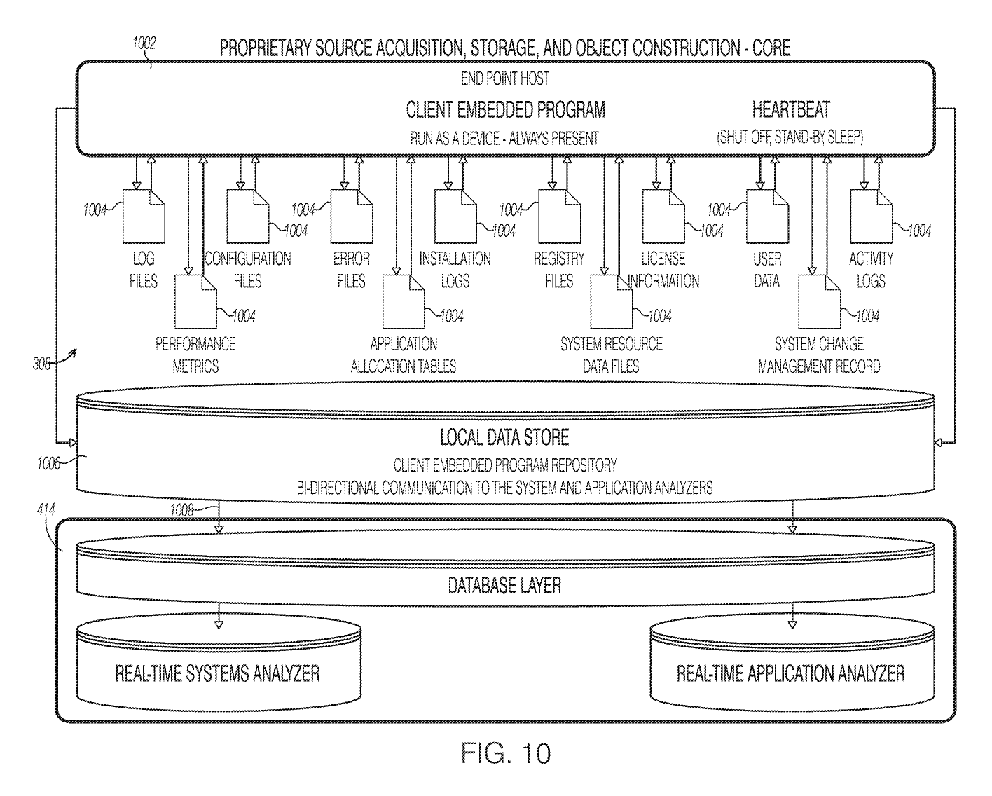

The components of a BCEP 308 are depicted in FIG. 10. Specifically, BCEP 308 includes an executable program 1002, which makes up the core program that runs upon a client component 310. Executable program 1002 in turn may rely upon a variety of resource files 1004, which are local to executable program 1002 and preferably contained upon client component 310. FIG. 10 shows examples of resource files, although a person skilled in the relevant art will understand that the listed files may vary depending upon the nature of client component 310, the rules 318 established for autonomic layer 302, and ultimately the needs and policies of the enterprise or organization deploying system 300. Furthermore, executable program 1002 sends and receives data to/from a local data store 1006, which serves essentially as a buffer or cache for information being sent to or received from BCEP 308's corresponding sister CEP 306. Thus, local data store 1006 is essentially the landing zone for all communications between client component 310 and autonomic layer 302. This is further demonstrated as local data store 1006 is shown in communication with real-time storage and systems analyzer layer 414, such communication handled by way of sister CEP 306.

BCEP 308 may be configured to periodically report status to sister CEP 306 (and by extension, to autonomic layer 302), and/or to respond to direct requests from autonomic layer 302 by way of sister CEP 306. BCEP 308 is the way by which autonomic layer 302 manages client component 310; in this way, BCEP 308 is the “hands and feet” as well as the “eyes and ears” of autonomic layer 302 to client component 310.

It will be appreciated by a person skilled in the relevant art that BCEP 308 will potentially be deployed to a wide range of client components 310, with carrying architectures. As a result, executable program 1002 is preferably implemented in such a fashion that it can be compiled and ran on multiple different architectures, such as Intel iAPX processors commonly found in most PC and Mac computers, ARM-based processors found in many mobile devices and tablets, and other RISC type processors that may be found in higher-end servers. Such implementation may include hard-coding several versions of BCEP 308 for various architectures, or implementing BCEP 308 using a platform-agnostic technology, such as Java. In any deployment, BCEP 308 must be engineered to run at a level of interaction with client component 310 and any associated software such the BCEP 308 can take control of managing client component 310, as well as intercept any and all user interactions with client component 310.

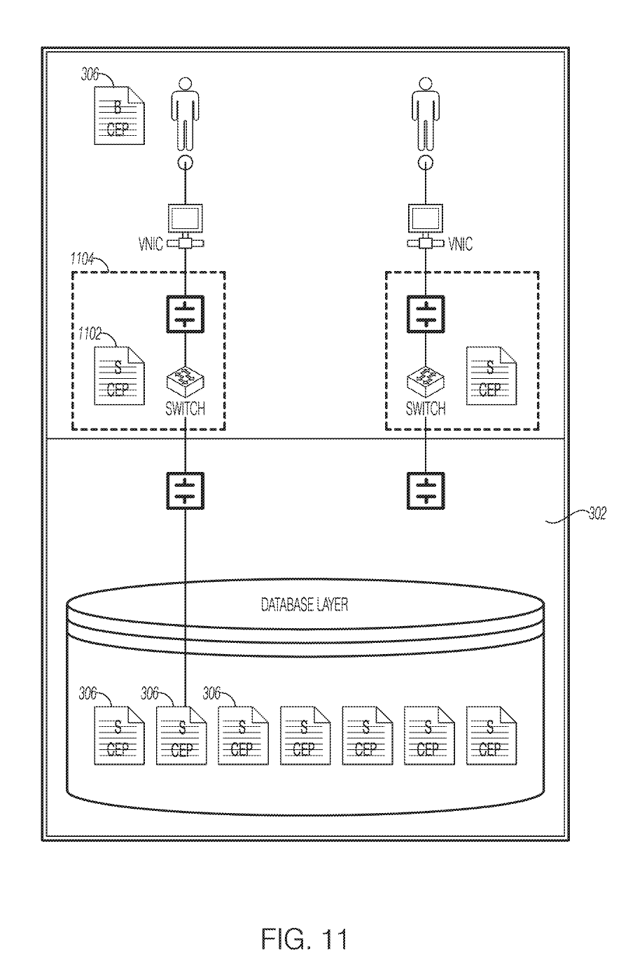

FIG. 11 shows an additional layer of communication that is preferably deployed in system 300 to enhance system security. While in some embodiments sister CEPs 306 communicate directly with their corresponding brother CEPs 308 on client components 310 that are directly operated by users, a more secure environment can be created by adding a switch CEP 1102 that runs upon and controls a switch 1104. Switch 1104, which is designed to switch data and computing objects under similar principles as a firewall or network switch, is placed in a quarantine or “demilitarized” landing zone. Users do not have direct access to switch 1104. Instead, switch 1104 is managed by autonomic layer 302 and only handles incoming requests from BCEPs 308 that are located on user facing client components 310. Thus, data flows from a BCEP 308 to switch CEP 1102 to sister CEP 306, and back through the same path. Switch CEP 1102, as it operates on switch 1104 that is walled off from any direct user interaction, can inspect requests from BCEP 308 for integrity and compliance with established enterprise rules (such as rules 418) before passing to BCEP's 308 corresponding sister CEP 306 within autonomic layer 302.

Such rules and compliance checking can extend to intrusion detection. As BCEPs 308 and sister CEPs 306 can be configured to log all interactions with system 300, when autonomic layer 302 detects a possible intrusion or attempt to compromise the enterprise system, autonomic layer 302 can learn the fingerprint of any attack, formulate and adapt management policies and rules to counter the attack in future encounters, and further generate a fingerprint that can be supplied to forensics and/or law enforcement authorities for further action.

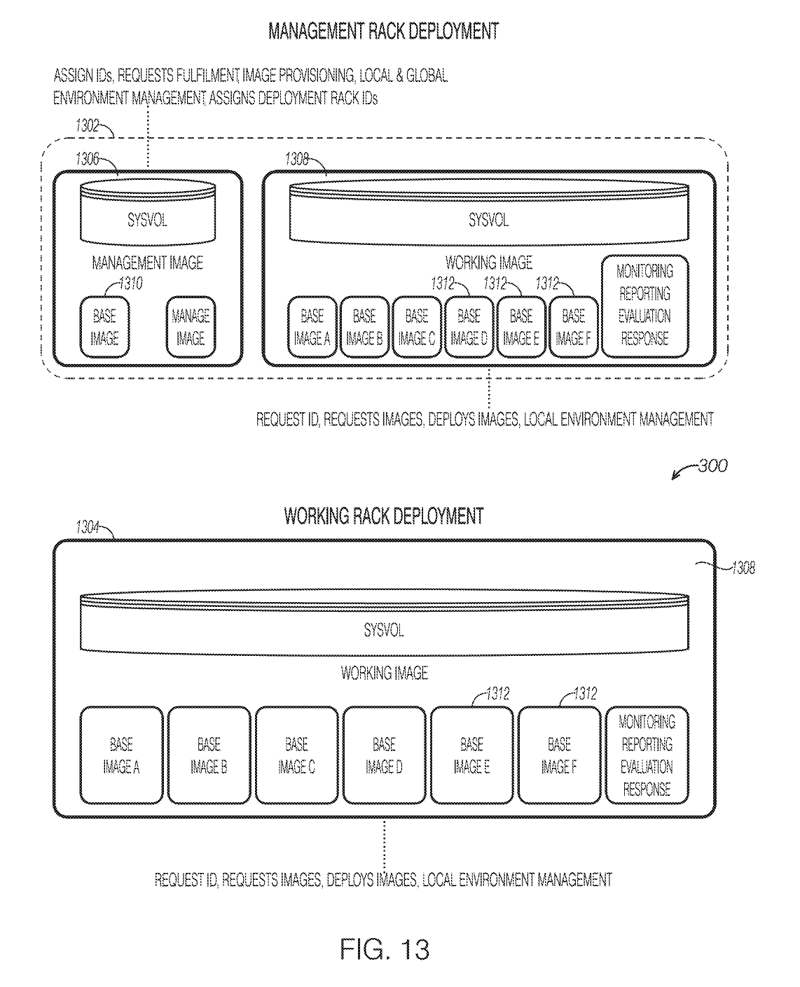

Referring now to FIG. 13, system 300 is ideally implemented as one or more rack appliances 1302 and 1304. Rack appliances may be divided into specific functionalities including computing platform appliances, which are focused on configuration and management of the various servers, desktops, and laptops in the organization; network appliances, which focus on configuration and management of network infrastructure such as wireless access points, switches, gateways, and routers; and security appliances, which manage enterprise security concerns, such as firewall configuration, VPN connections, intrusion prevention and detection, data integrity, and establishing and enforcing security policies. It will be obvious to a person skilled in the relevant art that these three types of dedicated appliances will work in concert and may overlap in their relevant domains to effect complete management of the enterprise IT infrastructure.

In other examples, the specific functionalities of system 300 described above can be implemented on a single appliance, or can be implemented in software only, running on virtual servers that are in turn executed on a single physical machine. The specific functionalities can also be implemented in a single, integrated monolithic software layer. For purposes of this application, “rack” and “rack appliance” equally apply to configurations of system 300 that are implemented using only a software stack, and broadly refer to the software in conjunction with the hardware upon which the software is run, whether a dedicated rack appliance or a generic computer system.

As can be seen in FIG. 13, a system 300 has at least one rack appliance 1302 that is designated as a management rack. Additional rack appliances 1304 are identified as working racks, that can each independently carry out IT management tasks for the systems and infrastructure they are respectively assigned to manage. All working racks 1304 report to and receive instructions from management rack 1302. In most implementations, and in particular where there is a single rack appliance 1302, that rack appliance 1302 acts as both a management rack and working rack; this is shown in FIG. 13, where management rack 1302 includes a management image 1306 and associated data images, and a working image 1308. Dedicated working racks 1304 contain only a working image 1308. Working racks 1304 can receive a copy of the working image 1308 from management rack 1302 upon commissioning of a new working rack 1304. Thus, additional working racks 1304 can be added to system 300 in essentially a plug and go fashion; a new working rack 1304 is attached to a network managed by system 300, looks for a management rack 1302, and receives all necessary images to join into autonomic layer 302.

Management rack 1302 serves as a master console for the entire enterprise, and is where company managers can monitor and manage the IT infrastructure at a high level, as well as provide strategic goals and administrative constraints that feed into the management rack's management algorithms. Management rack 1302 also serves as a repository for system images and information that are to be deployed by the working racks in the course of IT management, and collects information from the working rack to enable IT infrastructure monitoring. Management rack 1302 includes a base image 1310, which can be utilized by autonomic layer 302 for deployment of additional client components 310, such as provisioning servers, laptops, desktops, mobile devices, etc., or to refresh/reset client components 310 that may have become corrupted or compromised.

Management rack 1302 transmits base image 1310 to working rack(s) 1304, which may replicate and modify various copies of base images 1312 for deployment on the variety of client components 310 that are to be managed.

All rack appliances 1302 utilize a modular software architecture, which includes a variety of libraries and modules for reporting, planning, and management. Working racks 1304 can be deployed to help enable system 300 to scale to arbitrarily large enterprises. As the volume of data handled by system 300 increases in relation to the size of the enterprise, whether a working rack 1304 is needed, and the number of additional working racks 1304, will depend upon enterprise size as well as the hardware capabilities of each rack device.

As can be understood from the foregoing descriptions of the various layers of autonomic layer 302, system 300 presents an autonomic layer 302 with an AI engine 402 that runs along and down the other, lower layers of autonomic layer 302, as it manages interactions between all layers. By managing interactions between all layers, AI engine 402 can track interactions and use this input to feed into its management algorithms. This enables system 300 to anticipate changing system requirements, and detect when either system maintenance or diagnostics may be required, or, where IT infrastructure is reaching capacity, quickly deploy additional resources on spare capacity, e.g. by deploying virtual servers and provisioning necessary software, depending on the resource or resources that are reaching capacity. Likewise, with input from enterprise strategic goals and planning, system 300 can anticipate when resources may reach capacity, and schedule additional resources to be provisioned in advance of anticipated demands, thereby ensuring the enterprise always has sufficient IT infrastructure capacity.

System 300 preferably works with an IT infrastructure that is configured to allow flexible provisioning and deployment of resources, and is equipped with some amount of spare capacity. For example, an IT infrastructure that is based around virtual server deployments provides an ideal environment to be managed by system 300. Virtual server deployments typically employ a number of physical servers that have high capacity in terms of resources, e.g. disk space, processor cores, memory, network bandwidth, etc., and then run multiple instances of server software using virtualization technology that is well-known in the IT industry. As most servers spend a majority of the time sitting idle, provisioning multiple different virtual servers on a single physical box makes better use of idle processing power, thereby allowing multiple servers through a single piece of hardware with only a modest increase in cost over a single physical server, and substantially less than having multiple physical servers. By having one or more physical machines capable of dynamically provisioning additional servers, system 300 can interact with the physical machines and, using the library of server images and other automation techniques, automatically provision and configure additional servers of various types based upon measured and predicted enterprise needs.

Similarly, system 300 can provision desktops and/or laptop machines for new employees with simple notification of an employee start date and role; system 300 can be initially instructed as to the IT needs of each employee role.

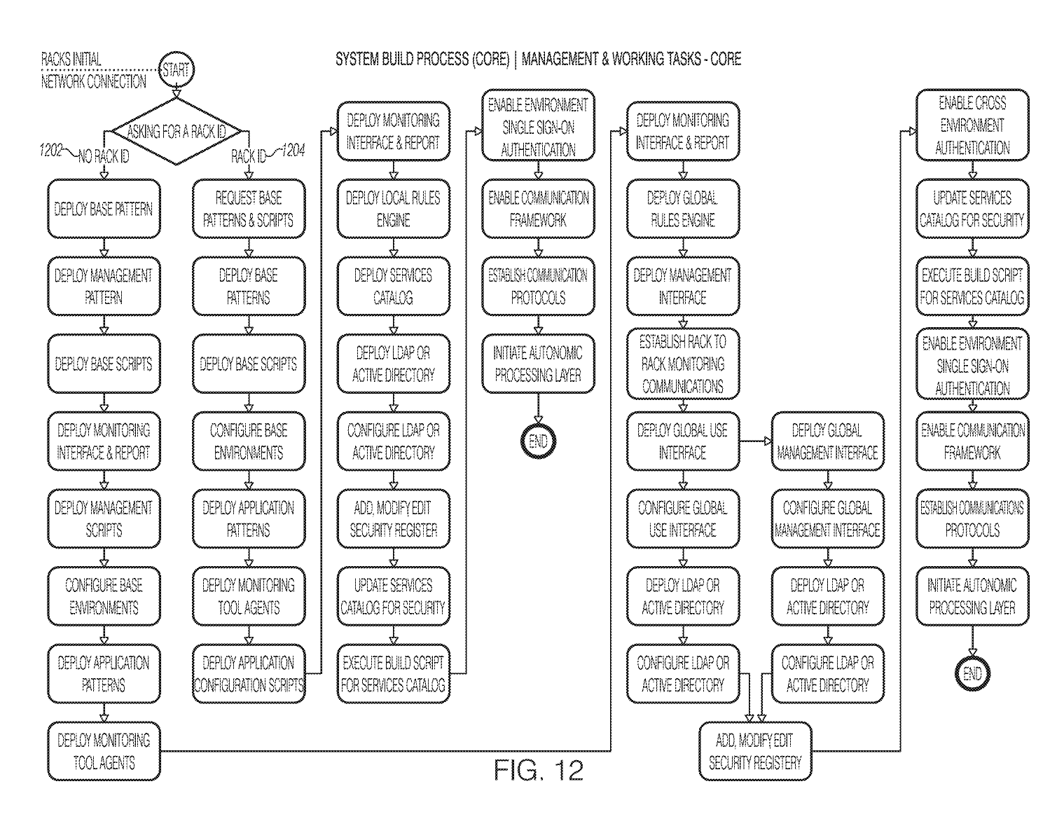

FIG. 12 shows the process and steps taken by a newly installed management rack 1302 and working rack 1304, as it initializes and configures the IT infrastructure environment for management. For an initial deployment of a system 300 where the rack appliance is going to become management rack 1302, path 1202 is taken, with the management rack 1302 establishing system 300 and placing itself into the management rack role. Where a management rack 1302 is already in existence, path 1204 is taken, for initialization of a new working rack 1304 by receiving the necessary data and images from management rack 1302.

Of note are the steps involving the deployment of agents, software programs that run on computers and hook into the operating system level to provide an interface for monitoring and management of the computer and all installed software, and modification of network security and directory services to establish security control over the managed infrastructure. Given the modular nature of system 300, appropriate modules 502 and BCEPs 308 can be provided that allow system 300 to initialize and hook into an infinite variety of infrastructure configurations, including any operating system, whether mobile, desktop, or server, and associated application software. Furthermore, the modular nature of system 300 allows for system 300 to be updated to accommodate custom software and configurations by the simple addition of new modules. It will be appreciated by a person skilled in the relevant art that the steps depicted in FIG. 12 may vary depending upon the particular configuration of the enterprise system upon which system 300 is deployed.

From a security standpoint, user-based security profiles along with traditional mechanisms such as system/directory/file level permissions and access control lists can be superseded by organization job role profiles. In such implementations system 300 could be configured to automatically manages necessary access on the basis of a user's known assigned job role. For example, if a user is assigned a managerial role, the artificial intelligence engine can automatically determine appropriate access permissions based upon the known needs of that role. Conversely, where the role is production-oriented, as opposed to managerial, these access permissions may be changed so that the user automatically and dynamically is allowed access to system resources necessary to the user's production role; access to resources that are necessary for managerial roles only would be restricted or denied.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A system for automated management of a computing environment including one or more client components, comprising:
a storage unit configured to store processor executable instructions, wherein the processor executable instructions further comprise:
an autonomic layer comprised of
a management image including management protocols, and
one or more sister client embedded programs; and
one or more brother client embedded programs;
wherein:
each of the one or more brother client embedded programs is executed upon one of the one or more client components;
each of the one or more brother client embedded programs has, and is in data communication with, a corresponding one of the one or more sister client embedded programs; and
the autonomic layer employs artificial intelligence algorithms to automatically probe each of the one or more client components of the computing environment and adapt the management protocols to changes in the computing environment, by communicating with the brother client embedded program executing on each of the one or more direct components via each brother client embedded program's corresponding sister client embedded program.

2. The system of claim 1, wherein the management image is further comprised of the management image and one or more working images.

3. The system of claim 1, wherein the autonomic layer is further comprised of an artificial intelligence engine, system interrogation layer, system database layer, systems rules and algorithms layer, real-time storage and systems analyzer layer, and governance and compliance layer.

4. The system of claim 3, wherein the artificial intelligence engine is further comprised of independent modules that are in data communication with each other.

5. The system of claim 4, wherein the management protocols are based upon a set of algorithm-based rules that are unique to the computing environment.

6. The system of claim 1, further comprising one or more switch client embedded programs, and wherein each brother client embedded program is in data communication with its corresponding sister client embedded program through a switch client embedded program.

7. The system of claim 6, wherein the processor executable instructions for the autonomic layer are executed upon a management server.

8. The system of claim 7, wherein the management server comprises one or more standalone rack mount servers.

9. A method of automatically managing a computing environment comprised of a plurality of client components, comprising:
establishing an autonomic layer on a management server, the autonomic layer further comprising an artificial intelligence engine;
establishing algorithm-based rules specific to the computing environment;
configuring the artificial intelligence engine with the algorithm-based rules to manage the computing environment;
establishing a brother client embedded program on each of the plurality of client components;
establishing a plurality of sister client embedded programs within the autonomic layer, each of the plurality of sister client embedded programs corresponding to and in two-way data communication with one of the brother client embedded programs; and
using the artificial intelligence engine to manage each of the plurality of client components through each of the brother client embedded programs and corresponding sister client embedded programs.

10. The method of claim 9, further comprising:
establishing one or more switch client embedded programs; and
configuring each of the brother client embedded programs and corresponding sister client embedded programs to be in two-way data communication through one of the one or more switch client embedded programs.

11. The method of claim 10, wherein the artificial intelligence engine further comprises a plurality of management modules.

12. The method of claim 10, further comprising intercepting by one of the brother client embedded programs all user input into a client component, and passing the input to the brother client embedded program's corresponding sister embedded program for further processing in accordance with algorithm-based rules.

13. The method of claim 10, further comprising:
configuring each brother client embedded program and corresponding sister client embedded program to monitor the status of its respective client component; and
configuring the autonomic layer to dynamically reconfigure the plurality of client components in response to changing user needs, in accordance with the algorithm-based rules.

14. The method of claim 13, further comprising configuring the autonomic layer to dynamically adjust management of the computing environment based upon the algorithm-based rules in response to changes in the computing environment.

15. The method of claim 14, further comprising:
configuring the autonomic layer to probe the computing environment to discover and determine the nature and status of each of the plurality of client components; and
deploying a brother client embedded program upon any of the plurality of client components that the autonomic layer determines does not have a brother client embedded program and a corresponding sister client embedded program within the autonomic layer.

16. The method of claim 10, further comprising configuring the autonomic layer to isolate all client components from any direct interactions apart from the autonomic layer.

17. A management server, comprising:
a processor configured to execute instructions;
a network interface in data communication with the processor and configured to communicate with client components over a network; and
a storage device in data communication with the processor and configured to store processor executable instructions, wherein the instructions comprise:
an autonomic layer further comprised of an artificial intelligence engine, system interrogation layer, system database layer, systems rules and algorithms layer, real-time storage and systems analyzer layer, and governance and compliance layer,
a brother client embedded program configured to be instantiated upon each of the network connected client components, and
a sister client embedded program configured to be instantiated within the autonomic layer for each brother client embedded program;
wherein:
the autonomic layer is configured to discover all network connected client components, instantiate a brother client embedded program upon each network connected client component, and manage each network connected client component via its instantiated brother client embedded program.

18. The management server of claim 17, wherein each brother client embedded program is configured to communicate with a corresponding sister client embedded program via a switch client embedded program.

19. The management server of claim 18, wherein the server is further comprised of one or more rack mountable appliances.

20. The management server of claim 19, wherein each client component is a server, desktop, laptop, tablet, smartphone, network device, or mobile device.
